(19) United States
(12) Patent Application Publication
(10) Pub. No.: US 2007/0054834 A1
(43) Pub. Date: Mar. 8, 2007

(54) Quaternary ammonium halides for treatment of infectious conditions

(75) Inventor: James R. Baker, Ann Arbor, MI (US)

Correspondence Address: FOLEY AND LARDNER LLP;SUITE 500, 3000 K STREET NW, WASHINGTON, DC, 20007, US

(73) Assignee: NanoBio Corporation

(21) Appl. No.: 11/400,795

(22) Filed: Apr. 10, 2006

Related U.S. Application Data
(60) Provisional application No. 60/669,879, filed on Apr. 11, 2005.

(51) Int. Cl. C11D 3/00

(52) U.S. Cl. 510/504

(57) ABSTRACT

Compositions comprising quaternary ammonium halides and methods of using the compositions comprising quaternary ammonium halides to treat and/or prevent infectious conditions in humans are provided.

This application claims the benefit of U.S. provisional application No. 60/669,879, filed on Apr. 11, 2005.

### BACKGROUND OF THE INVENTION

Pathogenic microorganisms, such as bacteria, fungi, viruses, and bacterial spores, are responsible for a plethora of human and animal ailments. Although antibiotic and antimicrobial therapies are effective and a mainstay of modern medicine, these therapies suffer from several disadvantages. For example, bacterial strains can develop antibiotic resistance. A person infected with an antibiotic resistant strain of bacteria faces serious and potentially life-threatening consequences, because antibiotics cannot eliminate the infection. Pneumococci, which cause pneumonia and meningitis, Salmonella and E. coli which cause diarrhea, and enterococci which cause blood stream, surgical wound, and urinary tract infections can all develop antibiotic resistance resulting in fatal infections. Moreover, antibiotics are not effective in eliminating or inactivating bacterial spores and viruses.

Viruses are additional pathogens that infect humans and animals which currently lack effective means of inactivation. For example, influenza A virus is a common respiratory pathogen widely used as a model system to test anti-viral agents in vitro and in vivo. The envelope glycoproteins of influenza A, hemagglutinin (HA) and neuraminidase (NA), which determine the antigenic specificity of viral subtypes, mutate readily, rendering antibodies incapable of neutralizing the virus. While influenza vaccines are available, not all individuals receive the vaccine nor is the vaccine 100% effective in preventing influenza infection. Current anti-viral compounds and neuraminidase inhibitors are minimally effective and viral resistance is common.

Fungi also can also infect humans and animals and are particularly serious in immunocompromised patients, such as HIV patients and some cancer patients. These infections can often be treated by antifungal drugs, but the number of antifungal drugs is limited especially for treatment of systemic fungal infections. In addition, these drugs can cause significant side effects.

Disinfectant and bacteriostatic compounds, such as sodium hypochlorite, formaldehyde and phenols, effectively kill pathogenic microorganisms. However, these disinfectants are not well suited for treating human patients. These compounds are frequently toxic in humans and can cause tissue necrosis and severe pulmonary injury following contact or inhalation of volatile fumes among other side effects.

Quaternary ammonium halides are known to exhibit antimicrobial properties against a broad range of pathogenic microorganisms. This characteristic has been exploited to develop sanitizers and other disinfectant products containing quaternary ammonium compounds. Examples of known applications include medical instrument sterilization, mouthwashes, disinfectants, water sanitizers, and skin cleansers.

Current therapeutic agents for use in treatment or prevention of infectious conditions caused by pathogenic microorganisms suffer from a number of limitations, including (1) limited efficacy against a broad range of pathogenic microorganisms requiring expensive and time-consuming diagnostic tests; (2) unacceptable side-effects due to toxicity; and (3) expense. Agents that can effectively kill a broad range of pathogenic microorganisms, such as quaternary ammonium compounds, are known, but these agents have not been developed into effective compositions for treatment of a broad range of infectious conditions in humans.

### SUMMARY OF THE INVENTION

Accordingly, there remains a need in the art for anti-pathogenic compositions effective for treatment and prevention of pathogenic infection in humans which exhibit a favorable toxicity profile. To address these and other needs, quaternary ammonium halides to treat and/or prevent a wide range of infectious conditions caused by pathogenic microorganisms in humans are provided.

One embodiment provides a composition comprising at least one quaternary ammonium halide, wherein the composition is therapeutically effective for the treatment of an infectious condition in a subject caused by a bacterium, fungus, a virus or a combination thereof, and wherein if the infectious condition is caused by a herpes virus, the quaternary ammonium halide is not benzalkonium chloride.

Another embodiment relates to a composition comprising at least one quaternary ammonium halide, wherein the composition is therapeutically effective for the treatment of a sexually transmitted disease in a subject caused by a bacterium, fungus, a virus or a combination thereof, and wherein if the infectious condition is caused by a herpes virus, the quaternary ammonium halide is not benzalkonium chloride.

Another embodiment provides a method of treating an infectious condition in a subject comprising administering to the subject a composition comprising at least one quaternary ammonium halide, wherein the composition is therapeutically effective for the treatment of the infectious condition, and wherein if the infectious condition is caused by a herpes virus, the quaternary ammonium halide is not benzalkonium chloride.

Yet another embodiment relates to a method of preventing sexually transmitted disease in a subject comprising administering to the subject a composition comprising at least one quaternary ammonium halide, wherein the composition is therapeutically effective for the prevention of the sexually transmitted disease, and wherein if the infectious condition is caused by a herpes virus, the quaternary ammonium halide is not benzalkonium chloride.

### DETAILED DESCRIPTION

The inventors have discovered that compositions comprising quaternary ammonium halides can be used to treat and/or prevent a wide range of infectious conditions in humans caused by pathogenic microorganisms. Quaternary ammonium halide compositions can avoid the limitation of traditional antibiotics, which are typically effective against only one class of bacteria, because compositions comprising at least one quaternary ammonium halide can be used to treat infections caused by different classes of bacteria. This feature can allow treatment to begin more quickly without the need for expensive and time-consuming diagnostic tests.

Unless otherwise specified, “a” or “an” means “one or more.” As used herein, the term “pathogenic microorganism” refers to a biological microorganism that is capable of producing an undesirable effect upon a human. Examples of pathogenic microorganisms include, but are not limited to, viruses, bacteria, fungi, spores, and the like. Pathogenic microorganism includes all such biological microorganisms whether naturally occurring or engineered.

Moreover, in addition to broad efficacy against microorganism, quaternary ammonium halide compositions show low toxicity in humans. In one embodiment, compositions comprising at least one quaternary ammonium halide have the benefit of being relatively inexpensive compared to antibiotics and easy to store. These characteristics may be particularly desirable when responding to a large-scale outbreak of an infectious condition, as in the case of an act of bioterrorism.

1. Therapeutic Quaternary Ammonium Halide Compositions

Useful compositions comprise any suitable quaternary ammonium halide. Quaternary ammonium halides can be selected based on sustainability for a particular application or based on some other consideration, such as biocompatibility. Suitable quaternary ammonium halides include, but are not limited to, cetylpyridinium halides, cetyltrimethylammonium halides, cetyldimethylethylammonium halides, cetyldimethylbenzylammonium halides, cetyltributylphosphonium halides, dodecyltrimethylammonium halides, tetradecyltrimethylammonium halides, alkylbenzyldimethylammonium salts alkyltrimethylammonium bromide, benzalkonium chloride, benzethonium chloride, benzyldimethylhexadecylammonium chloride, benzyldimethyltetradecylammonium chloride, benzyldodecyldimethylammonium bromide, benzyltrimethylammonium tetrachloroiodate, dimethyldioctadecylammonium bromide, dodecylethyldimethylammonium bromide, dodecyltrimethylammonium bromide, dodecyltrimethylammonium bromide, ethylhexadecyldimethylammonium bromide, hexadecyltrimethylammonium bromide, hexadecyltrimethylammonium bromide, trimethyl(tetradecyl)ammonium bromide, and combinations comprising one or more of the foregoing compounds. Halides include chloride, fluoride, bromide and iodide. In one embodiment, the halide is chloride or bromide. In another embodiment, the quaternary ammonium halide is cetylpyridinium chloride, benzalkonium chloride, or a combination thereof.

The composition can contain from 0.5% or less by weight of a quaternary ammonium halide. In another embodiment, the composition can contain 0.3%. In a further embodiment, a composition contains between approximately 0.1% and approximately 0.001% or 0.01% and approximately 0.0001% of a quaternary ammonium halide by weight of a quaternary ammonium halide.

Quaternary ammonium halide compositions can comprise more than one type of quaternary ammonium halide. For example, quaternary ammonium halide compositions can comprise two, three, four, or more different species of quaternary ammonium halide. In one embodiment, the quaternary ammonium halide composition comprises benzalkonium chloride. In another embodiment, the quaternary ammonium halide composition comprises cetylpyridinium chloride. In a further embodiment, the quaternary ammonium halide composition comprises both benzalkonium chloride and cetylpyridinium chloride.

Compositions comprising quaternary ammonium halides can further comprise therapeutic agents other than quaternary ammonium halides. A “therapeutic agent” is any compound that decreases the infectivity, morbidity, and/or rate of mortality associated with a pathogenic microorganism. Examples of suitable therapeutic agents include, but are not limited to, antimicrobial agents, antiviral agents, antifungal agents, and the like, and combinations comprising one or more of the foregoing agents. There are many antimicrobial agents currently available for use in treating bacterial, fungal and viral infections. Generally, antimicrobial agents include, but are not limited to, for example, agents that inhibit cell wall synthesis (e.g., penicillins, cephalosporins, cycloserine, vancomycin, bacitracin), imidazole antifungal agents (e.g., miconazole, ketoconazole and clotrimazole), agents that act directly to disrupt the cell membrane of the microorganism (e.g., polymyxin and colistimethate and the antifungals nystatin and amphotericin B), agents that affect the ribosomal subunits to inhibit protein synthesis (e.g. chloramphenicol, the tetracyclines, erythromycin and clindamycin), agents that alter protein synthesis and lead to cell death (e.g. aminoglycosides), agents that affect nucleic acid metabolism (e.g. the rifamycins and the quinolones), antimetabolites (e.g., trimethoprim and sulfonamides), and the nucleic acid analogues (e.g. zidovudine, gangcyclovir, vidarabine, and acyclovir) which act to inhibit viral enzymes essential for DNA synthesis. Any of these therapeutic agents, and others, may be incorporated into the compositions.

Examples of suitable therapeutic agents as well as their indications and dosages may be found in THE MERCK MANUAL OF DIAGNOSIS AND THERAPY § 13, Chapters 153-154, 158 (Mark H. Beers & Robert Berkow eds., 17^{th} ed. 1999), which is hereby incorporated by reference in its entirety. For example, suitable antibacterial therapeutic agents include, but are not limited to, β-lactams, aminoglycosides, macrolides, tetracyclines, quinolones, and sulfonamides. Suitable antiviral therapeutic agents include, but are not limited to, idoxuridine (IDU), vidarabine (adenine arabinoside, ara-A), trifluridine (trifluorothymidine), acyclovir, famciclovir, penciclovir, valacyclovir, ganciclovir, foscamet, ribavirin, amantadine, rimantadine, cidofovir (cytosine; HPMPC), immune globulins, and interferons. Suitable antifungal therapeutic agents include, but are not limited to, amphotericin B, ketoconazole, fluconazole, itraconazole, and flucytosine.

Compositions comprising at least one quaternary ammonium halide can further comprise at least one active ingredient. An “active ingredient” is any agent that affects a physiological response. An active agent can be selected depending on the intended use of the composition. Suitable classes of active agents include, but are not limited to, analgesics, fever-suppressants, anti-inflammatory agents, anti-diarrhea agents, sedatives, decongestants, cough suppressants, and anti-nausea agents.

Additional active ingredients and therapeutic agents can be selected based on indication. For example, a fever suppressant and an analgesic can be selected as additional active ingredients in a composition comprising at least one quaternary ammonium halide formulated for treating and/or preventing influenza. A composition for the treatment of influenza can also comprise an antiviral therapeutic agent used for the treatment of influenza. In another example, a composition comprising at least one quaternary ammonium halide formulated for treating and/or preventing sexually transmitted diseases can contain additional therapeutic agents known for the treatment of sexually transmitted diseases, such as ceftriaxone, ciprofloxacin, ofloxacin, cefixime, doxycycline, or azithromycin.

Quaternary ammonium halide compositions can be in forms suitable for oral, rectal, vaginal, injection (intravenous, subcutaneous, intramuscular, intraperitoneal, or intramammary), intranasal, intratracheal, or topical administration. Rectal, oral, and vaginal compositions may be in aqueous solution, suspension, tablet, capsule, douche, or pill form, for example. Compositions for topical administration may be formed for administration to skin and/or mucosal membranes. Compositions for injection may be in any form suitable for administration, such as an aqueous suspension or an emulsion. Compositions for inhalation may be in any form suitable for administration, such as a suspension, mist, or powder. Compositions for topical administration may be in forms, such as, but not limited to, gels, creams, lotions, suspensions, emulsions, ointments, foams, pastes, or powders.

In one embodiment, quaternary ammonium halide compositions can be made into gel form by using gelling agents. Suitable gelling agents include, for example, hydrogels such as, Natrosol® 250H NF (Hercules, Inc. Wilmington, Del.). A hydrogel can be added at a concentration of about 0.5 wt % to about 5 wt %, based on the total volume of the gel. Other suitable gelling agents include, but are not limited to, about 0.05 wt % to about 3 wt % cellulose polymer, such as cellulose gum or cationic guar derivatives, and up to about 10 wt % petrolatum, glycerin, polyethylene glycol, incroquat behenyl TMS, cetyl palmitate, glycerol stearate, and the like.

Quaternary ammonium halide compositions can comprise a pharmaceutically acceptable carrier. A pharmaceutically acceptable carrier or excipient suitable for a solid preparation such as tablets or capsules can be, for example, binders (e.g., acacia, gelatin, dextrin, hydroxypropylcellulose, methylcellulose, polyvinylpyrrolidone), solvents, dispersion media, diluents (e.g., lactose, sucrose, mannitol, corn starch, potato starch, calcium phosphate, calcium citrate, crystalline cellulose), lubricants (e.g., magnesium stearate, calcium stearate, stearic acid, talc, anhydrous silicic acid), disintegrants (e.g., corn starch, potato starch, carboxymethylcellulose, carboxymethylcellulose calcium, alginic acid), and wetting agents (e.g., sodium laurylsulfate). A pharmaceutically acceptable carrier or excipient suitable for a liquid preparation, such as solutions or suspensions, can be, for example, aqueous vehicles (e.g., water), suspending agents (e.g., acacia, gelatin, methyl cellulose, carboxymethylcellulose sodium, hydroxymethyl-cellulose, aluminum stearate gel), surfactants (e.g., lecithin, sorbitan monooleate, glycerin monostearate), and non-aqueous vehicles (e.g., glycerin, propylene glycol, vegetable oil). Moreover, liquid preparations may contain preservatives (e.g., p-hydroxybenzoic acid methyl ester, p-hydroxybenzoic acid propyl ester), flavors, and/or coloring agents.

Suitable carriers include, but are not limited to, calcium carbonate, carboxymethylcellulose, cellulose, citric acid, dextrate, dextrose, ethyl alcohol, glucose, hydroxymethylcellulose, lactose, magnesium stearate, maltodextrin, mannitol, microcrystalline cellulose, oleate, polyethylene glycols, potassium diphosphate, potassium phosphate, saccharose, sodium diphosphate, sodium phosphate, sorbitol, starch, stearic acid and its salts, sucrose, talc, vegetable oils, water, and combinations comprising one or more of the foregoing carriers. Additional examples of pharmaceutical carriers include those described in REMINGTON'S PHARMACEUTICAL SCIENCES, 15th Ed. Easton: Mack Publishing Co. pp. 1405-1412 and 1461-1487 (1975), and THE NATIONAL FORMULARY XIV 14th Ed., Washington: American Pharmaceutical Association (1975), which references are hereby incorporated by reference in their entirety. The use of such media and agents for pharmaceutically active substances is well known in the art. Except insofar as any conventional media or agent is incompatible with the compositions, their use in therapeutic compositions is contemplated.

Compositions can further comprise an emollient, especially when the composition is intended for topical administration. Suitable emollients include, but are not limited to, glycerin, propylene glycol, and similar ingredients disclosed in the INTERNATIONAL COSMETIC INGREDIENT DICTIONARY AND HANDBOOK Vol. 4 (9^{th}. ed.

2002), more particularly the emollients disclosed on pages 2930-2936. The disclosure of the INTERNATIONAL COSMETIC INGREDIENT DICTIONARY AND HANDBOOK Vol. 4, pages 2930-2936, is hereby incorporated by reference in its entirety.

Compositions comprising quaternary ammonium halide compounds can contain at least one chelating agent. Suitable chelating agents include ethylenediaminetetraacetic acid (EDTA), ethylenebis(oxyethylenenitrilo)tetraacetic acid (EGTA), and combinations thereof. Chelating agents can be prepared in water or in a buffer, such as, for example, TRIS buffer. Chelating agents can be premixed with an aqueous phase or can be added to a diluent. Chelating agents can be used at a concentration of about 1 μM to about 50 mM, based on the total volume of the composition. In one embodiment, the concentration of the chelating agent is between about 100 μM to about 50 mM. In a further embodiment, the concentration of chelating agent can be greater than or equal to about 25 μM, greater than or equal to about 50 μM, greater than or equal to about 70 μM greater than or equal to about 80 μM, greater than or equal to about 100 μM, greater than or equal to about 1 mM, or greater than or equal to about 2 mM. In an additional embodiment, the concentration of chelating agent can be less than or equal to about 40 mM, less than or equal to about 27 mM, less than or equal to about 25 mM, less than or equal to about 10 mM, or less than or equal to about 5 mM.

Compositions can further comprise any number of additional compounds depending on the desired application. For example, topical compositions may further comprise agents, such as sweeteners, perfumes, coloring agents, sunscreens, thickening agents, moisturizers, retinoids, time release agents, stabilizers, sequestering agents, enzymes, or any other ingredient commonly used in pharmaceutical compositions. These additional compounds may be readily selected by one of ordinary skill in the art depending on the particular intended application of the composition.

Compositions comprising quaternary ammonium halides can be formulated to treat various infections caused by pathogenic microorganisms. In one embodiment, compositions comprising quaternary ammonium halides are formulated to treat a broad range of infections. In one embodiment, compositions comprising quaternary ammonium halides are formulated to treat a particular family of infections, such as herpes, sexually transmitted disease, respiratory infections (e.g., SARS, pneumonia), common colds, or flu.

Compositions comprising quaternary ammonium halides can be formulated to treat and/or prevent infectious conditions caused by, for example, B. anthracis, B. cereus, B. circulans, B. megaterium, B. subtilis, C. botulinum, C. tetani, C. perfringens, H. influenzae, N. gonorrhoeae, S. agalactiae, S. pneumonia, S. pyogenes, V. cholerae, S. aureus, Yersinia species, G. vaginalis, G. mobiluncus, M hominis, Salmonellae species, Shigellae species, Pseudomonas species, Eschericia species, Klebsiella species, Proteus species, Enterobacter species, Serratia species, Moraxella species, Legionella species, Bordetella species, Helicobacter species, Micrococcus species, Listeria species, Corynebacteria species, Nocardia species, Mycobacteria species, or a combination thereof. In some embodiments, compositions comprising quaternary ammonium halides can be formulated to treat and/or prevent infectious conditions caused by B. anthracis, H influenzae, N. gonorrhoeae, S. pneumonia, S. pyogenes, S. aureus, Yersinia species, G. vaginalis, Salmonellae species, Pseudomonas species, Eschericia species, Klebsiella species, Proteus species, or a combination thereof.

Compositions comprising at least one quaternary ammonium halide can be formulated to treat and/or prevent infectious conditions caused by viruses belonging to one of the Herpesviridae, Bunyaviridae, Orthomyxoviridae, Retroviridae, Papovaviridae, Hepadnaviridae, Coronaviridae, Flaviviridae, Togaviridae, Picornaviridae, Filoviridae, Paramyxoviridae, or Rhabdoviridae families, for example. In one embodiment, the Orthomyxoviridae virus is influenza virus, the Herpesviridae is herpes simplex and herpes zoster, the Paramyxoviridae is sendai virus, the Togaviridae is sindbis virus, the Poxyiridae is small pox, or vaccinia virus. In one embodiment, the Retroviridae is human immunodeficiency virus, the Flaviviridae is West Nile virus, the Bunyaviridae is hanta virus, and the Papillomaviridae is human papilloma virus. Examples of infectious conditions that may be treated and/or prevented using the methods and compositions described herein include, but are not limited to, HIV, shingles, herpes (any variety), flu, cold, West Nile Virus infection, encephalitis, and Severe Acute Respiratory Syndrome (SARS). In some embodiments, the compositions can methods described herein can be used to treat and/or prevent infectious conditions caused by Orthomyxoviridae, Herpesviridae, Poxyiridae, or Retroviridae.

Compositions comprising at least one quaternary ammonium halide may be formulated to treat and or prevent infectious conditions caused by fungi. Examples of fungi causing infectious conditions that can be treated and/or prevented include, but are not limited to, yeast (e.g., Candida species) and filamentous fungi, including dermatophytes. Examples of infectious fungal conditions that can be treated and/or prevented using the compositions described herein include, but are not limited to, Tinea and onychomycosis (caused by Trichophyton rubrum, T mentagrophytes, T tonsurans, T schoenleini, Microsporum canis, M gypseum and Epidermophyton floccosum), Aspergillosis (Aspergillus), Blastomycosis (Blastomyces dermatitidis), Coccidioidomycosis (Coccidioides), Cryptococcosis (Cryptococcus neoformans), onychomycosis (i.e., nail infections), histoplasmosis (Histoplasma capsulatum), Mucormycosis (Mucorales), Paracoccidioidomycosis (Paracoccidioides brasiliensis), Sporotrichosis (Sporothrix schenckii), and coccidioidomycosis (Coccidioides immitis).

Quaternary ammonium halide compositions can be formulated to treat sexually transmitted diseases. Examples of sexually transmitted diseases that can be treated or prevented using quaternary ammonium halides include, but are not limited to, herpes labialis (cold sores), genital herpes (herpes simplex viruses type 1 (HSV-1) and type 2 (HSV-2)), bacterial vaginosis, chlamydia (Chlamydia trachomatis), gonorrhea (Neisseria gonorrhoeae), genital warts (papillomavirus (HPV)), syphilis (Treponema pallidum), trichomoniasis (Trichomonas vaginalis), hepatitis (HAV, HBV, and HCV), chancroid (Haemophilus ducreyi), crabs (Pthirus pubis), and molluscum contagiosum virus (MCV).

2. Methods of Treating Infectious Conditions with Quaternary Ammonium Halides

Infectious conditions caused by a wide-range of pathogenic microorganisms can be treated or prevented in humans using quaternary ammonium halide compositions. Administering a composition comprising at least one quaternary ammonium halide has the benefit of being effective against a broad spectrum of pathogenic microorganisms avoiding time-consuming and expensive diagnostic tests. The infectious conditions can be caused by a bacterium, a virus, a fungus, any other pathogenic microorganism, or combinations thereof. In one embodiment, a method of treating and/or preventing an infectious condition comprises administering at least one quaternary ammonium halide. The quaternary ammonium halide can be selected from any suitable quaternary ammonium halide. In another embodiment, the quaternary ammonium halide is benzalkonium chloride. In a further embodiment, the quaternary ammonium halide is cetylpyridinium chloride. In yet another embodiment, the quaternary ammonium halide composition comprises benzalkonium chloride and cetylpyridinium chloride.

Examples of infectious conditions that can be treated using the compositions and methods described herein include, but are not limited to, sexually transmitted diseases, such as genital herpes and AIDS, tinea infection, onychomycosis, shingles, and vaginal infections. In addition, the compositions can be used to prevent infections caused by pathogenic microorganisms, such as Severe Acute Respiratory Syndrome (SARS), influenza, genital herpes, the common cold, syphilis, Chlamydia, genital warts (human papillomavirus), and HIV. In one embodiment, bacterial infections treatable and/or preventable with quaternary ammonium halide compositions include those caused by Gram positive, Gram negative, atypical (Mycoplasma and Chlamydia species, for example), and/or an acid fast bacillus (Mycobacteria).

Examples of bacteria that can be treated using the methods provided herein include B. anthracis, B. cereus, B. circulans, B. megaterium, B. subtilis, C. botulinum, C. tetani, C. perfringens, H. influenzae, N. gonorrhoeae, S. agalactiae, S. pneumonia, S. pyogenes, V cholerae, S. aureus, Yersinia species, G. vaginalis, G. mobiluncus, M hominis, Salmonellae species, Shigellae species, Pseudomonas species, Eschericia species, Klebsiella species, Proteus species, Enterobacter species, Serratia species, Moraxella species, Legionella species, Bordetella species, Helicobacter species, Arihobacter species, Micrococcus species, Listeria species, Corynebacteria species, Planococcus species, Nocardia species, Rhodococcus species, Mycobacteria species, or a combination thereof.

Infectious conditions caused by viruses can also be treated and/or prevented by administering a composition comprising at least one quaternary ammonium halide. The virus can belong to one of the Herpesviridae, Bunyaviridae, Orthomyxoviridae, Retroviridae, Papovaviridae, Hepadnaviridae, Coronaviridae, Flaviviridae, Togaviridae, Picornaviridae, Filoviridae, Paramyxoviridae, or Rhabdoviridae families, for example. In one embodiment, the Orthomyxoviridae virus is influenza virus, the Herpesviridae is herpes simplex and/or herpes zoster, the Paramyxoviridae is sendai virus, the Togaviridae is sindbis virus, the Poxyiridae is small pox, or vaccinia virus. In one embodiment, the Retroviridae is human immunodeficiency virus, the Flaviviridae is West Nile virus, the Bunyaviridae is hanta virus, and the Papillomaviridae is human papilloma virus. Examples of infectious conditions that can be treated using the methods and compositions described herein include, but are not limited to, HIV, shingles, herpes (any variety), flu, cold, West Nile virus infection, encephalitis, and Severe Acute Respiratory Syndrome (SARS).

Quaternary ammonium halide can be used for the treatment and/or prevention of infectious conditions caused by fungi. Examples of fungi that may be treated include, but are not limited to, yeast (e.g., Candida species) and filamentous fungi including dermatophytes. Examples of infectious conditions that can be treated and/or prevented using the methods and compositions described herein include, but are not limited to, Tinea and onychomycosis (caused by Trichophyton rubrum, T mentagrophytes, T tonsurans, T schoenleini, Microsporum canis, M gypseum and Epidermophytonfloccosum), Aspergillosis (Aspergillus), Blastomycosis (Blastomyces dermatitidis), Coccidioidomycosis (Coccidioides), Cryptococcosis (Cryptococcus neoformans), onychomycosis (i.e., nail infections), histoplasmosis (Histoplasma capsulatum), Mucormycosis (Mucorales), Paracoccidioidomycosis (Paracoccidioides brasiliensis), Sporotrichosis (Sporothrix schenckii), and coccidioidomycosis (Coccidioides immitis).

Quaternary ammonium halide compositions can be administered in any suitable manner, such as orally, rectally, vaginally, topically, intranasally, intratracheally, or by injection (intravenous, subcutaneous, intramuscular, intraperitoneal, or intramammary). For example, infectious conditions causing the common cold or influenza can be treated by administering an intranasal spray comprising at least one quaternary ammonium halide. In another embodiment, a skin infection caused by a pathogenic microorganism can be treated by applying a topical preparation comprising at least one quaternary ammonium halide to the site of the infection. In yet another embodiment, a gastrointestinal infection can be treated by orally administering a composition comprising at least one quaternary ammonium halide. In a further embodiment, the composition may be applied topically to the mucosa of a subject. Mucosal administration may be particularly useful in preventing and/or treating sexually transmitted infections. For example, in one embodiment, a method of preventing and/or treating herpes comprises administering a composition comprising at least one quaternary ammonium halide to the vaginal mucosa.

Quaternary ammonium halide compositions can be administered in any suitable form depending on the particular application. For example, the compositions may be administered as pills, tablets, lozenges, capsules, sprays, lotions, creams, gels, foams, powders, douches, and suspensions. The dosage forms may comprise one or more pharmaceutically effective carriers. The dosage forms may contain other inactive ingredients including but not limited to, fragrances, flavoring, gelling agents, and colorings.

A method of treating and/or preventing an infectious condition can comprise administering a composition comprising at least one quaternary ammonium halide and at least one other active ingredient and/or therapeutic agent. The other active ingredient and/or therapeutic agent can be administered simultaneously (same or different dosage form), before, or after the composition comprising at least one quaternary ammonium halide. In one embodiment, the other therapeutic agent is another quaternary ammonium halide. In another embodiment, the other therapeutic agent can be an antibiotic, antifungal, or antiviral drug other than a quaternary ammonium halide. In a further embodiment, the additional active ingredient will be an analgesic, cough suppressant, fever suppressant, anti-inflammatory, anti-diarrheal, decongestant, or sedative agent.

Compositions comprising at least one quaternary ammonium halide can be administered using any suitable dosage schedule. In one embodiment, a composition comprising at least one quaternary ammonium halide is administered at least once a day to treat and/or prevent an infectious condition. In another embodiment, a composition comprising at least one quaternary ammonium halide is administered more than once a day to treat and/or prevent an infectious condition. In a further embodiment, a composition comprising at least one quaternary ammonium halide is administered only when needed, such as when potentially exposed to pathogenic microorganisms. For example, the composition comprising at least one quaternary ammonium halide can be administered immediately before and/or after sexual intercourse.

Quaternary ammonium halide compositions can be used to treat sexually transmitted diseases, including, but not limited to, herpes labialis (cold sores), genital herpes (herpes simplex viruses type 1 (HSV-1) and type 2 (HSV-2)), bacterial vaginosis, chlamydia (Chlamydia trachomatis), gonorrhea (Neisseria gonorrhoeae), genital warts (papillomavirus (HPV)), syphilis (Treponema pallidum), trichomoniasis (Trichomonas vaginalis), hepatitis (HAV, HBV, and HCV), chancroid (Haemophilus ducreyi), crabs (Pthirus pubis), and molluscum contagiosum virus (MCV).

In one embodiment, quaternary ammonium halide compositions can be used to prevent sexually transmitted diseases, such as herpes and HIV. For example, a quaternary ammonium halide composition may be applied to the vaginal or male genital area in the form of a liquid, paste, gel, cream, lotion, or foam before, during, or after sexual intercourse to prevent disease transmission. In one embodiment, the quaternary ammonium halide composition will contain additional ingredients, such as lubricants or spermicides. As another example, quaternary ammonium halide compositions can be applied to a birth control device, such as a condom, intrauterine device, or sponge, to prevent sexually transmitted diseases. These birth control devices can be pre-packaged with the quaternary ammonium halide composition, or the quaternary ammonium halide composition may be applied by the end-user. The quaternary ammonium halide composition may be in any form, such as a liquid, suspension, paste, gel, cream, lotion, or foam.

A method of treating and/or preventing colds also is provided comprising administering a composition comprising at least one quaternary ammonium halide. Colds are caused by a large number of viruses including rhinoviruses, coronaviruses, adenoviruses, coxsackieviruses, echoviruses, orthomyxoviruses (including influenza A and B viruses), paramyxoviruses (including several parainfluenza viruses), respiratory syncytial virus, and enteroviruses. In one embodiment, the composition comprising at least one quaternary ammonium halide is administered as an intranasal spray. The nasal spray composition can include additional active ingredients, such as decongestants, sedatives, analgesics, and/or cough suppressants. In other embodiments, the composition comprising at least one quaternary ammonium halide is orally administered, such as in the form of a pill, tablet, capsule, or lozenge. In another embodiment, a composition is administered orally. Oral compositions can include flavoring and pharmaceutically acceptable carriers. In one embodiment, the compositions are administered at least once daily. For example, the compositions may be administered one, two, three, four, or more times each day for preventing and/or treating colds caused by a wide array of viruses.

A method of treating and/or preventing influenza (influenza A or B) is provided comprising administering a composition comprising at least one quaternary ammonium halide. Compositions comprising at least one quaternary ammonium halide can be administered in any suitable form to treat and/or prevent influenza. In one embodiment, the composition comprising at least one quaternary ammonium halide can be administered as a nasal spray. In another embodiment, the nasal spray can be administered at least once a day, and in another embodiment, administered two, three, four, or more times a day. In a further embodiment, the composition comprising at least one quaternary ammonium halide can be administered as a lozenge. The lozenge can have additional ingredients, such as active ingredients (analgesics, fever suppressants, etc.), flavorings, and/or colorings. For example, the lozenge can be administered after influenza symptoms first develop, and in other embodiments, the lozenge can be administered before symptoms develop as a preventative measure.

Gastrointestinal infections can be treated using compositions comprising at least one quaternary ammonium halide. Gastrointestinal infections can be caused by a large number of pathogenic microorganisms including, but not limited to, viruses, bacteria, protozoans, and fungi, capable of causing nausea, vomiting, abdominal pain, and diarrhea. A method is provided to treat gastrointestinal infections by administering a composition comprising at least one quaternary ammonium halide. In one embodiment, Gastrointestinal infections can be prevented by prophylactic administration of a quaternary ammonium halide composition.

Quaternary ammonium halide compositions are useful in a method of treating and/or preventing onychomycosis. Onychomycosis can be caused be a number of organisms, including, but no limited to, Trichophyton rubrum, Trichophyton mentagrophytes, Candida albicans, Candida parapsilosis, Epidermophyton floccosum, Microsporum audouinii, Microsporum canis, Microsporum gypseum, Trichophyton mentagrophytes, Trichophyton rubrum, Trichophyton schoenleinii, Trichophyton tonsurans, Acremonium species, Aspergillus species, Candida species, Fusarium oxysporum, Scopulariopsis brevicaulis, Onychocola Canadensis, and Scytalidium dimidiatum. A method of treating onychomycosis is provided comprising administering at least one quaternary ammonium halide is provided. In one embodiment, at least one additional therapeutic agent, such as terbinafine, itraconazole, or ciclopirox, can be administered. In one embodiment, the composition comprising at least one quaternary ammonium halide can be administered topically. In another embodiment, a quaternary ammonium halide can be administered topically in combination with an orally administered therapeutic agent. A topical composition can be supplied in the form of a lacquer or paint (such as a nail polish) that is applied to the nails.

Compositions comprising at least one quaternary ammonium halide may be used to prevent infections after exposure to known or unknown pathogenic microorganisms. Such exposure may be the result of accidental or intentional exposure. For example, accidental exposure to pathogenic microorganisms may occur among patients in hospitals, i.e., nosocomial infection. In one embodiment, a method of preventing infection after exposure to pathogenic microorganisms comprises administering at least one quaternary ammonium halide to at-risk individuals. By “at-risk individuals,” it is meant individuals with a heightened risk of being infected or at a heightened risk if infected. Examples of classes of “at-risk individuals” includes, but are not limited to, hospital patients, immuno-compromised individuals, and individuals exposed to a pathogenic microorganism intentionally or unintentionally. Prophylactic administration can prevent infection entirely or reduce the severity and/or duration of infection.

Quaternary ammonium halide compositions can be advantageously incorporated into a wide variety of products. In one embodiment, a quaternary ammonium halide compositions can be incorporated into a bandage or some other wound dressing. Applying this wound dressing to a subject can prevent and/or treat an infectious condition. This application can be particularly useful in patients unusually susceptible to infection, such as burn victims and immuno-compromised patients. In another embodiment, quaternary ammonium halide compositions can be incorporated into a swab. The swab can be used on a subject to administer a quaternary ammonium halide compositions contained on the swab. This application can be particularly useful in cleaning wounds. In a further embodiment, a quaternary ammonium halide composition can be incorporated with birth control devices, such as condoms, intrauterine devices, and sponges. The incorporation may be in the form of a liquid or gel coating, for example. This application may be particularly useful for preventing transmission of sexually transmitted diseases, such as HIV and herpes. In another embodiment, quaternary ammonium halide compositions can be incorporated into other medical or hygienic instruments, devices, and/or consumables to treat and/or prevent infectious conditions.

The following example is for the purposes of illustration only and is not meant as a comprehensive description of the invention nor should it be interpreted to limit the claims.

### EXAMPLE

The microbicidal effect of cetyl pyridinium chloride (CPC) was tested using a strain of Staphylococcus aureus. Specifically, S. aureus ATCC 6538 cultures were placed in three different test tubes. Different concentrations (0.1%, 0.01% or 0.001%) of CPC were added to each of the test tubes. The mixture of CPC and S. aureus was incubated for 10 minutes on a tube rotator at 37° C. The results are shown below in Table 1 as the log reduction in S. aureus count.

TABLE 1

| | CPC concentration | | |
|---|---|---|---|
| | 0.1% | 0.01% | 0.001% |
| Log reduction in S. aureus | 5.3 | 5.3 | 3.4 |
| count | | | |

While the specification is directed to exemplary embodiments, it will be understood by those skilled in the art that various changes may be made and equivalents may be substituted for elements thereof without departing from the scope of the invention as claimed. In addition, many modifications may be made to adapt a particular situation or material to the teachings of the invention as claimed without departing from the essential scope thereof. Therefore, it is intended that the invention as claimed not be limited to the particular embodiment disclosed as the best mode contemplated for carrying out this invention. All references and publications cited herein are incorporated by reference in their entireties.

What is claimed is:

1. A composition comprising at least one quaternary ammonium halide, wherein the composition is therapeutically effective for the treatment of an infectious condition in a subject caused by a bacterium, fungus, a virus or a combination thereof, and wherein if the infectious condition is caused by a herpes virus, the quaternary ammonium halide is not benzalkonium chloride.

2. The composition of claim 1, wherein the infectious condition is selected from the group consisting of fungal infection, bacterial infection, common cold, influenza, SARS, and HIV.

3. The composition of claim 1, wherein the infectious condition is selected from the group consisting of herpes labialis, onychomycosis, genital herpes, and shingles.

4. The composition of claim 4, wherein the quaternary ammonium halide is cetylpyridinium chloride.

5. The composition of claim 4, further comprising benzalkonium chloride.

6. The composition of claim 1, wherein the composition further comprises a pharmaceutically acceptable carrier.

7. The composition of claim 1, wherein the bacterium comprises a Gram negative bacteria, a Gram positive bacteria, an acid fast bacilli, or a combination thereof.

8. The composition of claim 1, wherein the bacterium comprises B. anthracis, B. cereus, B. circulans, B. megaterium, B. subtilis, C. botulinum, C. tetani, C. perfringens, H influenzae, N. gonorrhoeae, S. agalactiae, S. pneumonia, S. pyogenes, V cholerae, S. aureus, Yersinia species, G. vaginalis, G. mobiluncus, M. hominis, Salmonellae species, Shigellae species, Pseudomonas species, Eschericia species, Klebsiella species, Proteus species, Enterobacter species, Serratia species, Moraxella species, Legionella species, Bordetella species, Helicobacter species, Micrococcus species, Listeria species, Corynebacteria species, Nocardia species, Mycobacteria species, or a combination thereof.

9. The composition of claim 1, wherein the bacterium comprises B. anthracis, H. influenzae, N. gonorrhoeae, S. pneumonia, S. pyogenes, S. aureus, Yersinia species, G. vaginalis, Salmonellae species, Pseudomonas species, Eschericia species, Klebsiella species, Proteus species, or a combination thereof.

10. The composition of claim 1, wherein the virus belongs to a family selected from the group consisting of Herpesviridae, Bunyaviridae, Orthomyxoviridae, Retroviridae, Papovaviridae, Hepadnaviridae, Coronaviridae, Flaviviridae, Togaviridae, Picornaviridae, Filoviridae, or Paramyxoviridae.

11. The composition of claim 10, wherein the Orthomyxovirdae virus is influenza virus, the Herpesviridae is herpes simplex or herpes zoster, the Paramyxoviridae is sendai virus, the Togaviridae is sindbis virus, and the Poxyiridae is small pox or vaccinia virus.

12. The composition of claim 10, wherein the Retroviridae is human immunodeficiency virus, the Flaviviridae is west nile virus, the Bunyaviridae is hanta virus, and the Papillomaviridae is human papilloma virus.

13. The composition of claim 1, wherein the virus is human immunodeficiency virus.

14. The composition of claim 1, wherein the fungus is a yeast or a filamentous fungus.

15. The composition of claim 14, wherein the yeast is Candida.

16. The composition of claim 14, wherein the filamentous fungi is a dermatophyte.

17. The composition of claim 1, wherein the subject is a human.

18. The composition of claim 1, wherein the infectious condition is a sexually transmitted genital infection.

19. The composition of claim 18, wherein the sexually transmitted genital infection is selected from the group consisting of genital herpes, human papilloma virus, human immunodeficiency virus, trichomoniasis, gonorrhea, syphilis, and Chlamydia.

20. The composition of claim 1, wherein the composition is formulated for topical administration.

21. The composition of claim 1, wherein the step of administering comprises application of the composition to the mucosa of a subject.

22. A method of treating an infectious condition in a subject comprising administering to the subject a composition comprising at least one quaternary ammonium halide, wherein the composition is therapeutically effective for the treatment of the infectious condition, and wherein if the infectious condition is caused by a herpes virus, the quaternary ammonium halide is not benzalkonium chloride.

23. The method of claim 22, wherein the infectious condition is caused by a bacterium, a virus, a fungus, or a combination thereof.

24. The method of claim 22, wherein the infectious condition is selected from the group consisting of herpes labialis, onychomycosis, genital herpes, shingles, fungal infection, bacterial infection, common cold, influenza, SARS, gastrointestinal infection, and HIV.

25. The method of claim 22, wherein the quaternary ammonium halide is cetylpyridium chloride.

26. The method of claim 25, further comprising benzalkonium chloride.

27. The method of claim 22, wherein the composition further comprises a pharmaceutically acceptable carrier.

28. The method of claim 23, wherein the bacterium comprises a Gram negative bacteria, a Gram positive bacteria, an acid fast bacilli, or a combination thereof.

29. The method of claim 23, wherein the bacterium comprises B. anthracis, B. cereus, B. circulans, B. megaterium, B. subtilis, C. botulinum, C. tetani, C. perfringens, H. influenzae, N. gonorrhoeae, S. agalactiae, S. pneumonia, S. pyogenes, V. cholerae, S. aureus, Yersinia species, G. vaginalis, G. mobiluncus, M hominis, Salmonellae species, Shigellae species, Pseudomonas species, Eschericia species, Klebsiella species, Proteus species, Enterobacter species, Serratia species, Moraxella species, Legionella species, Bordetella species, Helicobacter species, Micrococcus species, Listeria species, Corynebacteria species, Nocardia species, Mycobacteria species, or a combination thereof.

30. The method of claim 23, wherein the bacterium comprises B. anthracis, H. influenzae, N. gonorrhoeae, S. pneumonia, S. pyogenes, S. aureus, Yersinia species, G. vaginalis, Salmonellae species, Pseudomonas species, Eschericia species, Klebsiella species, Proteus species, or a combination thereof.

31. The method of claim 23, wherein the virus belongs to a family selected from the group consisting of Orthomyxoviridae, Retroviridae, Papovaviridae, Hepadnaviridae, Coronaviridae, Flaviviridae, Togaviridae, Picornaviridae, Filoviridae, Paramyxoviridae, or Rhabdoviridae.

32. The method of claim 31, wherein the Orthomyxovirdae virus is influenza virus, the Herpesviridae is herpes simplex or herpes zoster, the Paramyxoviridae is sendai virus, the Togaviridae is sindbis virus, the Poxyiridae is small pox or vaccinia virus.

33. The method of claim 23, wherein the virus is influenza, herpes simplex, herpes zoster, small pox, or a combination thereof.

34. The method of claim 31, wherein the Retroviridae is human immunodeficiency virus, the Flaviviridae is west nile virus, the Bunyaviridae is hanta virus, and the Papillomaviridae is human papilloma virus.

35. The method of claim 23, wherein the fungus is a yeast or a filamentous fungus.

36. The method of claim 35, wherein the yeast is Candida.

37. The method of claim 35, wherein the filamentous fungi is selected from the group consisting of Trichophyton rubrum, T mentagrophytes, T tonsurans, T schoenleini, Microsporum canis, M gypseum and Epidermophyton floccosum.

38. The method of claim 22, wherein the subject is a human.

39. The method of claim 22, wherein the infectious condition is a sexually transmitted genital infection.

40. The method of claim 39, wherein the sexually transmitted genital infection is selected from the group consisting of genital herpes, human papilloma virus, human immunodeficiency virus, trichomoniasis, gonorrhea, syphilis, and Chlamydia.

41. The method of claim 22, wherein the step of administering comprises application of the composition to the mucosa of a subject.

42. The method of claim 22, wherein the step of administration comprises topical administration.

43. A method of preventing a sexually transmitted disease in a subject comprising administering to the subject a composition comprising at least one quaternary ammonium halide to the subject's genital area before, after, and/or during sexual intercourse, wherein the composition is therapeutically effective for the prevention of the sexually transmitted disease.

44. The method of claim 43, wherein the composition comprising at least one quaternary ammonium halide is administered in the form of a liquid, paste, gel, cream, lotion, or foam.

45. The method of claim 43, wherein the sexually transmitted disease to be prevented is selected from herpes, bacterial vaginosis, chlamydia, gonorrhea, genital warts, syphilis, trichomoniasis, hepatitis, chancroid, crabs, vaginosis, and AIDS.

46. The method of claim 43, wherein the composition comprising at least one quaternary ammonium halide is administered by a birth control device coated with the composition.

47. The method of claim 46, wherein the birth control device is selected from a condom, an intrauterine device, and a sponge.
